(19) United States
(12) Patent Application Publication
(10) Pub. No.: US 2011/0210693 A1
(43) Pub. Date: Sep. 1, 2011

(54) METHOD FOR POWERING A GOLF CART WITH SOLAR ENERGY

(76) Inventors: Chris John Reichart, (US); Gerald G. Glass, (US)

(21) Appl. No.: 12/699,674

(22) Filed: Feb. 3, 2010

(51) Int. Cl. H01M 10/46

(52) U.S. Cl. 320/101

(57) ABSTRACT

A method for generating electricity from solar power to a golf cart, relying on a photovoltaic panel (1) charge controller (5); batteries (11) golf cart electrical engine (7); electrical wires, and fuses. The photovoltaic panel will generate electrical power that will provide sufficient power to run the golf cart electrical motor.

### CROSS-REFERENCE TO RELATED APPLICATIONS

Ser. No. 12/426,927

### SEQUENCE LISTING OR PROGRAM

Not Applicable

### BACKGROUND

1. Field

This application relates to solar electricity generated by photovoltaic panels and the application to run the electrical engine of a golf cart.

2. Prior Art

This method relates to the solar power used to charge batteries specifically designed and dedicated to the operation of a golf cart. Solar power inventions have been around for a while, but no invention was ever created specifically to run a golf cart described herein. The average amount of power output generated by our method and unit is specifically designed to power a golf cart.

Examples of solar-power generators for vehicles are described in the following documents:

U.S. Pat. No. 5,725,062, which was issued to Froneck on Mar. 10, 1998 described a vehicle top solar power generator, where the solar panel is mounted on the top of the vehicle.

U.S. Pat. No. 4,602,694, which was issued to Weldin on Jul. 29, 1986, was limited to a detailed combination of a motor, a generator, a traction wheel and other devices.

U.S. Pat. No. 5,148,736 which was issued to Juang on Sep. 22, 1992, described an automatic solar-powered car ventilator.

U.S. Pat. No. 5,680,907, which was issued to Weihe on Oct. 28, 1997, described an auxiliary solar-power automobile drive system which would be an alternative source of power for the primary source of fossil fuel energy. This provided the logic but not a solution to provide enough solar power to an air handling unit or an electrical system for a tractor/trailer.

U.S. Pat. No. 6,380,481 which was issued to Muller on Apr. 30, 2002, involved solar panels which were used but they were retractable and the system was designed to run with the assistance of kinetic energy.

Our method involves a unit that is permanently affixed to the vehicle.

In a 1987 article, McCosh, D. “Racing with the Sun”, Popular Science Magazine, November 1987, McCosh noted that solar energy was a great source of electricity. There was no additional mention was made about powering a golf cart. Back in 1987 McCosh was hoping for a technical breakthrough which would reduce the cost of solar panels, and now 22 years later we have the method to generate electricity for the purpose of running a golf cart for a fraction of the cost, as sought in 1987.

In his book, Tertzakian, P. “A Thousand Barrels a Second: The Coming Oil Break Point and the Challenges Facing an Energy Dependent World”, McGraw-Hill Professional, 2006, 8,23,79, Tertzakian explained the importance of getting away from the “oil only world” we live in and start to build a portfolio of energy sources. Solar power is mentioned in his book as an important part of such an energy portfolio.

Finding a replacement for oil fuels is the main purpose of several books and authors in the recent years. In his book Campbell, C. J. “Oil Crisis,” multi-science publishing, 2005, 303, also brought up the necessity of finding alternative energy sources.

### SUMMARY

In light of the publicly perceived need for solar energy for transportation vehicles and/or at minimum the supplementation of the power source for the vehicle, the object of our method is to provide a solar power source to a golf cart. This document will describe the construction of a device capable of providing a solar energy power source to operate a golf cart. This method is powered by solar power and is designed using readily available products. The solar output of this device is approximately 200 Watts, 24 Volts and 15 Amperes. The system can be configured for different levels of desired power, current and/or voltages, but our system is optimized for usage at this configuration. The batteries used for this project are approximately 12 Volts (can be any range but usually are between 6 and 12 volts), 15-30 amperes per hour.

All of the energy generated by the solar panels is stored in batteries which have the following characteristics:
Completely sealed valve regulated;
Flame arresting pressure regulated safety sealing valves;
Operating pressure management and protection against atmospheric contamination;
Computer-aided 99.994% pure heavy-duty lead calcium grid designs;
Tank formed plates, which guarantees evenly formed and capacity matched plates;
Anchored plate groups, to guard against vibration;
Double insulating micro porous glass fiber separators;
Measured and immobilized electrolyte, for a wide range of operating temperatures, and low self discharge rates
High impact reinforced strength copolymer polypropylene cases with flat top designed covers that are rugged and vibration resistant;
Thermally welded case to cover bonds that eliminate leakage;
Copper and stainless steel alloy terminals and hardware;
Multi-terminal options;
Terminal protectors;
Removable carry handles; and
Classified as “NON-SPILLABLE BATTERY” Not restricted for Air (IATA/ICAO) Provision 67, Surface (DOT-CFR-HMR49) or Water (Classified as non-hazardous per IMDG amendment 27) transportation, compatible with sensitive electronic equipment, Quality Assurance processes with ISO (4400/992579), QS and TUV Certification EMC tested, CE, ETTS Germany (G4M19906-9202-E-16), Tellcordia and Bellcore compliant, UL recognized and approved components (MH29050).

The method utilizes electrical connections with heavy duty cables with a zinc die-cast plug housing. Which is reinforced for durability, good recoil memory, chemical resistance and abrasion resistance. A temperature rating of −90° F. to 125° F. (−68° C. to 52° C.), unbreakable PERMAPLUGS™ featuring Dupont® patented material, which meets SAE J560. Large finger grips for coupling/uncoupling, even with gloves on. Extended plug interior for easy maintenance, protected with anti-corrosive non-conductive, dielectric lithium grease. All cable assemblies are rated for 12 volt systems. All electrical wires connect with the STA-DRY® Wire Insertion Socket, 7-Way #16-720D, with split brass pins along with Anti-Corrosive Dupont Super-Tuff Nylon® housing & lid and stainless steel hinge pin & spring, with inner cavity sealed to prevent contaminants from passing to the wire harness. Extended front barrels for additional cable support, slanted 5° for moisture drain, and elongated holes for mounting adaptability.

Electricity is generated by photovoltaic solar panels, as well by other means. Each solar panel has the following characteristics: rated power (Pmax) 165-210 W, production tolerance +/−5%; by-pass Diodes connected across every solar cell to protect the solar cell from power loss in case of partial shading or damage of individual solar cells while other cells are exposed to full sunlight. (mainly with crystalline and with laminates panels).

To secure the unit to the vehicle's roof (either metal bracing that sits upon the existing roof, or the roof can be modified and changed to accept the solar panel in a more seamless fashion, which will not obstruct the aerodynamics of the vehicle. for tax incentives and rebates (as well as the traditional crystalline modules).

The logical center for this method is a charge controller. The charge controller we selected has the following characteristics: MPPT (Maximum Power Point) battery charging; 3-position battery select (gel, sealed, flooded or lithium ion); very accurate control and measurement jumper to eliminate telecom noise; parallel for up to 30 Amperes temperature compensation; tropicalization: conformal coating, stainless-steel fasteners & anodized aluminum heat sink, no switching or measurement in the grounded leg, 100% solid state, very low voltage drops, current compensated low voltage disconnect, leds for battery status and faults indication, capable of 25% overloads, remote battery voltage sense terminals. The charge controller has the following electronic protections: short-circuit for solar and load, overload for solar and load, reverse polarity, reverse current at night, high voltage disconnect, high temperature disconnect, lightning and transient surge protection, loads protected from voltage spikes, automatic recovery with all protections.

This method is designed to provide for approximately 9 hours of operation, with a requirement of approximately 4 hours of sunlight for a full charge. The photovoltaic panels used in this method are amorphous silicon. By the properties of its construction the panels are capable of using different spectrums of light in which to operate and allow for a broader range of usable sunlight.

The average golf cart requires 200 Watts for operation. Our method generates approximately 200 Watts, which is sufficient to provide power to the golf cart. The surplus provides enough power for the charge controller to maintain the necessary charge on the battery to extend battery life. Our method operates for approximately 9 hours with no sunlight.

### DRAWINGS

### Figures

The method for generating electricity from solar panels to run a golf cart is described by the appended claims in relation to the description of a preferred embodiment with reference to the following drawings which are described briefly as follows:

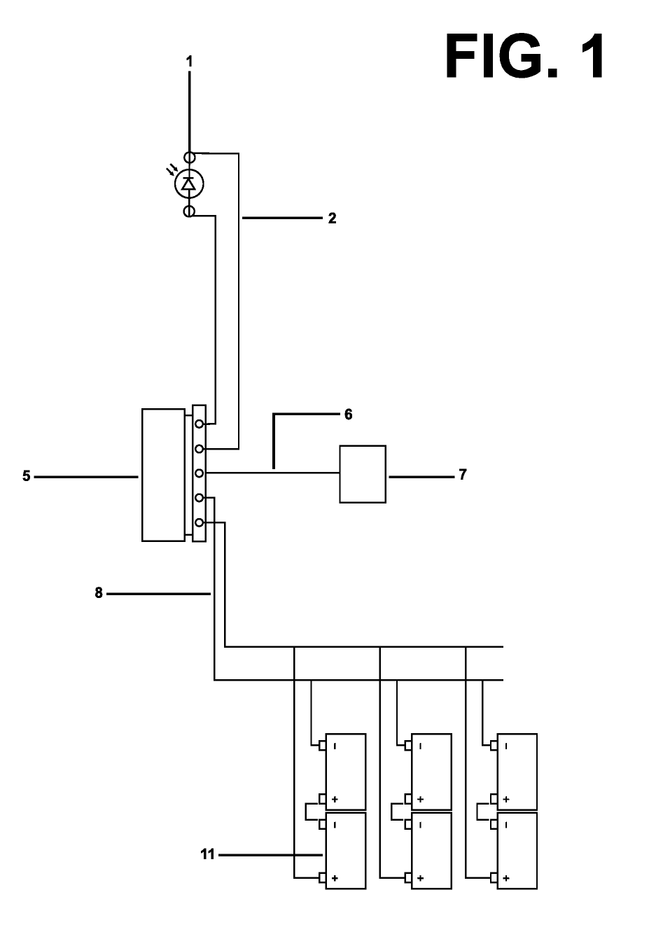

FIG. 1 is the electrical diagram of the method;

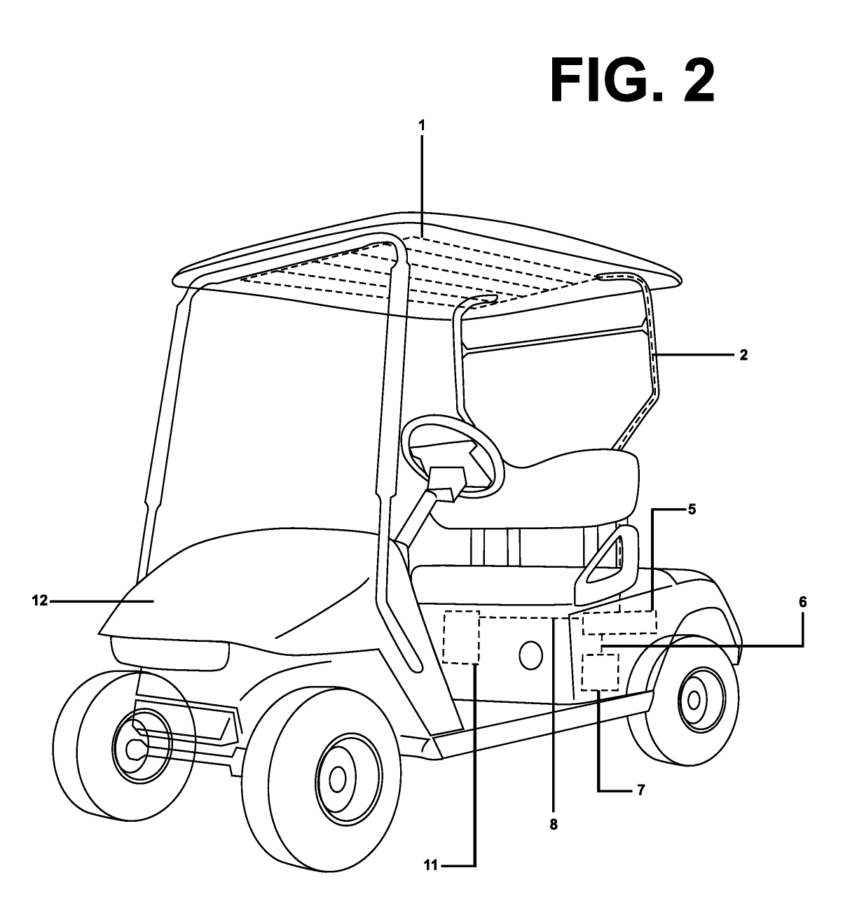

FIG. 2 is a partially cutaway top view.

### DETAILED DESCRIPTION

### FIGS. 1 and 2—First Embodiment

Reference is made first to FIG. 1. Photovoltaic (PV) panel 1 that receives solar energy. The electricity generated by the PV panel 1 is transmitted via a wire 2, to a charge controller 5. The charge controller 5 is designed to direct the electrical current from the PV panel 1 to a primary load 7 in this embodiment a golf cart 7 via a wire 6. If the primary load 7 is not receiving the electricity generated by the PV panel 1 the charge controller 5 sends the electricity via a wire 8 to the batteries 11. The batteries 11 store the electricity generated by the PV panel 1. When there is no electricity generated by the PV panel 1 the charge controller 5 allows the electricity stored in the batteries 11 to be transmitted via wire 8, to the primary load 7. The charge controller 5 has the capability to be programmed to understand what are the circuit's electrical current needs. This is based on the program set in the charger controller 5 memory. The unit will be able to make logical decisions (based on the charger programmed data). If the load 7 needs power, the charge controller 5 sends electrical power to the load. If the batteries 11 are low in charge, the charge controller 5 sends power to the batteries 11.

As shown in FIG. 2, we show a golf cart 12, the batteries 11 will be assembled and installed under the golf cart, the PV panel 1 will be assembled and installed on the top of the golf cart. The wire 2 makes an approximately 60° bend and comes down to the side of the golf cart where it is going to be connected with the charge controller 5 which is also mounted in the back of golf cart 12.

After our method is completed and attached to the golf cart 12, our method will generate enough power to provide the load, which is the golf cart electrical engine. Although the foregoing invention has being described in some detail by way of illustration and example, for purposes of clarity and understanding, it is obvious that certain changes and modifications may be practiced within the scope of the appended claims.

1-7. (canceled)

8. A vehicle mounted solar power system comprising:
a vehicle;
at least one photovoltaic solar panel arranged on an exterior surface of the vehicle;
at least one electrical load of the vehicle;
at least one battery;
at least one charge controller electrically connected between the at least one solar panel, the at least one electrical load and the at least one battery, the at least one charge controller being configured to automatically:
detect solar panel power generation;
detect electrical load power consumption;
detect battery charge; and
selectively route power between the at least one solar panel, the at least one electrical load, and the at least one battery dependent on the detected power generation, power consumption and battery charge.

9. The system of claim 8, further comprising:
a first DC disconnect between the at least one solar panel and the at least one charge controller;
a second DC disconnect between the at least one battery and the at least one charge controller;
wherein the charge controller and the electrical load can be completely isolated from any power source by opening the first and second DC disconnects.

10. The system of claim 8, wherein the vehicle is a golf cart.

11. The system of claim 10, wherein the at least one solar panel is mounted on the roof of the gold cart.

12. The system of claim 11, wherein at least one additional photovoltaic solar panel is mounted on the roof of the golf cart and connected to the charge controller.

13. The system of claim 10, wherein the at least one electrical load is an electrical motor for the golf cart.

14. The system of claim 8, wherein the at least one solar panel is secured to the exterior surface of the vehicle by an adhesive.

15. The system of claim 14, wherein the at least one adhesive is an ethylene propylene copolymer adhesive and sealant, with a microbial inhibitor, high temperature and low light performance.

16. The system of claim 8, wherein the charge controller includes at least one of: short-circuit condition protection, overload condition protection, overtemperature protection, and surge protection.

17. The system of claim 16, wherein the charge controller includes all of: short-circuit condition protection, overload condition protection, overtemperature protection, and surge protection.

18. The system of claim 17, wherein the charge controller is further configured to automatically recover following a protective action.

19. The system of claim 8, wherein the charge controller include memory with program data stored therein.

20. The system of claim 19, wherein based on the program data includes at least the following rules for selectively routing power between the at least one solar panel, the at least one electrical load, and the at least one battery:
if the at least one solar panel is generating electrical power and the at least one load requires electrical power, then power is routed from the at least one solar panel to the at least one load;
if the at least one solar panel is not generating electrical power and the at least one load requires electrical power, then power is routed from the at least one battery to the at least one load;
if the at least one solar panel is generating electrical power, the electrical power is not require by the at least one load and the charge of the at least one battery is low, then power is routed from the at least one solar panel to the at least one battery.

21. The system of claim 8, wherein the charge controlled is adapted for pulse width modulated (PWM) battery charging.

22. A method of operating a golf cart-mounted solar power system, the method comprising:
arranging a charge controller between at least one golf cart-mounted photovoltaic solar panel, at least one golf cart-mounted battery and at least one golf cart electrical motor;
automatically detecting solar panel power generation, electrical load power consumption, and battery charge with the charge controller; and
selectively routing power between the at least one solar panel, the golf car electrical motor, and the at least one battery using the charge controller, dependent on the detected power generation, power consumption and battery charge.

23. The method of claim 22, further comprising isolating the at least one solar panel from the charge controller, the at least one golf cart-mounted battery and the golf cart electrical motor using a DC disconnect.

24. The method of claim 22, further comprising isolating the at least one battery from the charge controller, the at least one golf cart-mounted solar panel and the golf cart electrical motor using a DC disconnect.

25. The method of claim 22, further comprising the isolating the charge controller and the golf cart electrical motor from the at least one vehicle-mounted solar panel and the at least one battery using respective DC disconnects.
